(19) United States
(12) Patent Application Publication
(10) Pub. No.: US 2015/0282093 A1
(43) Pub. Date: Oct. 1, 2015

(54) APPARATUS, METHODS AND COMPUTER PROGRAMS FOR SIGNALLING TRANSMITTED OUTPUT POWER

(71) Applicant: RENESAS MOBILE CORPORATION, Tokyo (JP)

(72) Inventors: Jouni Kaukovuori, Vantaa (FI); Antti Immonen, Helsinki (FI)

(21) Appl. No.: 14/432,713

(22) PCT Filed: Oct. 1, 2013
(86) PCT No.: PCT/IB2013/059040

§ 371 Date: Mar. 31, 2015

(30) Foreign Application Priority Data
Oct. 1, 2012 (GB) 1217537.8

(51) Int. Cl. H04W 52/14; H04W 24/10; H04W 52/36

(52) U.S. Cl. CPC H04W 52/146; H04W 52/367; H04W 24/10; H04W 88/08

(57) ABSTRACT

A request for a capability report is sent to one or more user equipment from at least one access point (200). The requested capability report indicates an actual amount of maximum power reduction and/or additional maximum power reduction applied to one or more network signalling values by the one or more user equipment, which can be can be absolute values or delta. The capability report is sent only if it is determined that an actual amount of maximum.

### CROSS REFERENCE TO RELATED APPLICATION

This application claims the benefit under 35 U.S.C. §119 and 37 CFR §1.55 to UK patent application no. 1217537.8, filed on Oct. 1, 2012, the entire content of which is incorporated herein by reference.

### TECHNICAL FIELD

The present invention relates to apparatus, methods and computer programs generally for signalling transmitted output power. The example and non-limiting embodiments of this invention relate generally to wireless communication systems, methods, devices and computer programs, and, more specific examples, relate to reducing out-of-band emissions and spurious transmissions in a wireless communication system.

### BACKGROUND

The transmission output power reduction of a cellular radio transmitter transmitting in a Evolved Universal Terrestrial Radio Access Network (EUTRAN) is allowed in certain use scenarios to minimise undesired out-of-band (OOB) emissions and spurious transmissions to avoid interfering with other radio equipment or systems. See for example 3GPP TS 36.3101, V11.1.0 (2012-06), 3rd Generation Partnership Project; Technical Specification Group Radio Access Network; Evolved Universal Terrestrial Radio Access (E-UTRA); User Equipment (UE) radio transmission and reception (Release 11). For example, a power class 3 UE is required to control the maximum output power of its one or more transceivers, depending upon the type of modulation schemes (e.g. Quadrature Phase Shift Keying (QPSK) or quadrature amplitude modulation (QAM), one or more channel bandwidths and one or more transmission bandwidths relative to a number of transmitted resource blocks. As such, in certain situations, an evolved Node B (eNodeB) will (by way of network signalling (NS) values) transmit instructions to each UE to lower its maximum power to reduce OOB and spurious transmissions. These NS values are described as additional maximum power reduction (A-MPR) and are E-UTRAN band-specific values which are listed in Table 6.2.4-1 in the current 3GPP specification mentioned above.

Further reference tables also are provided in the current 3rd Generation Partnership Project (3GPP) specification describing A-MPR parameters for specific NS-values which segment assignments of Decibel (dB) levels pertaining to A-MPR into regions as a function of the number of resource blocks (RBs) and the RB index with large A-MPR dB levels specified (e.g. NS-07 for Band 13 has up to 12 dB assigned). The NS values were originally specified by the fourth technical specification group radio access networks WG4 (RAN4) responsible for handling radio performance and protocol aspect for long term evolution (LTE) and legacy RANs. However, RF components (e.g. radio frequency integrated circuits (RFICs), front-end modules, and power amplifiers (PAs) enhance and evolve. As such, the required A-MPR can be significantly lower than that announced by the above cited 3GPP specification, depending on the UE implementation and component selection. In other words, the A-MPR defined in the 3GPP specification is merely a fixed threshold declaring the maximum allowed power reduction value for UEs in LTE and legacy RANs. Currently, an eNodeB scheduler may assume that each UE utilises the maximum allowed A-MPR decibel accorded each NS value.

Accordingly, there is a need for one or more devices or apparatus, methods or computer programs which will propagate each UE's actual power reduction capabilities to all relevant eNodeB schedulers in a wireless communication system, thereby allowing eNodeB to enhance the systems throughput and coverage, for example.

The following abbreviations that may be found in the specification and/or the drawing figures are defined as follows:

3GPP 3rd Generation Partnership Project

A-MPR Additional Maximum Power Reduction

AP Access Point

BS Base Station

CA Carrier Aggregation

CBW Channel Bandwidth

CM Cubic Metric

DL Downlink

dB Decibel

eNodeB evolved Node B

E-UTRAN Evolved Universal Terrestrial Radio Access Network

FE Front-End

L_CRB Length Contiguous Resource Block

LTE Long Term Evolution

LTE-A Long Term Evolution-Advanced

LTE-B Long Term Evolution-Beyond

MPR Maximum Power Reduction

NS Network Signalling

OFDMA Orthogonal Frequency Division Multiple Access

OOB Out-of-Band Emissions

PAPR Peak-to-Average-Power Ratio

PA Power Amplifier

PHR Power Headroom Report

P-MPR Power Management Maximum Power Reduction

RFIC Radio Frequency Integrated Circuit

RB Resource Block

UE User Equipment

UL Uplink

### SUMMARY

According to a first aspect of the present invention, there is provided a method including sending a request to one or more user equipment for a capability report indicating an actual amount of maximum power reduction and/or additional maximum power reduction applied to one or more network signalling values, and selectively receiving the requested capability report from the one or more user equipment based upon one or more response criteria.

According to a second aspect of the present invention, there is provided apparatus including a processing system adapted to cause the apparatus to at least send a request to one or more user equipment for a capability report indicating an actual amount of maximum power reduction and/or additional maximum power reduction applied to one or more network signalling values, and selectively receive the requested capability report from the one or more user equipment based upon one or more response criteria.

There may be provided a computer program comprising a program of instructions executable by a machine for causing operations, said operations comprising: sending a request to one or more user equipment for a capability report indicating an actual amount of maximum power reduction and/or additional maximum power reduction applied to one or more network signalling values and selectively receiving the requested capability report from the one or more user equipment base upon one or more response criteria.

There may be provided apparatus including means for sending a request to one or more user equipment for a capability report indicating an actual amount of maximum power reduction and/or additional maximum power reduction applied to one or more network signalling values and means for selectively receiving the requested capability report from the one or more user equipment based upon one or more response criteria.

According to a third aspect of the present invention, there is provided a method including receiving a request from at least one access point for a capability report indicating an actual amount of maximum power reduction and/or additional maximum power reduction applied to one or more network signalling values, and selectively processing the request based upon one or more response criteria

According to a fourth aspect of the present invention, there is provided apparatus including a processing system adapted to cause the apparatus to at least receive a request from at least one access point for a capability report indicating an actual amount of maximum power reduction and/or additional maximum power reduction applied to one or more network signalling values, and selectively process the request based upon one or more response criteria.

There may be provided a computer program comprising a program of instructions executable by a machine for causing operations, said operations comprising receiving a request from at least one access point for a capability report indicating an actual amount of additional maximum power reduction applied to one or more network signalling values and selectively processing the request based upon one or more response criteria.

There may be provided apparatus including means for receiving a request from at least one access point for a capability report indicating an actual amount of additional maximum power reduction applied to one or more network signalling values, and means for selectively processing the request based upon one or more response criteria

The processing systems described above may include at least one processor and at least one memory which stores a computer program, the at least one memory with the computer program being configured with the at least one processor to cause the apparatus to at least operate as described above.

There may be provided a program storage device, including for example a computer-readable memory, readable by a machine and tangibly embodying a program of instructions as described above.

These and other embodiments and aspects are detailed below with particularity.

The foregoing and other aspects of the some example embodiments of this invention are further explained in the following Detailed Description, when read in conjunction with the attached Drawing Figures.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a schematic illustration of one possible deployment scenario involving out-of-band (OOB) and spurious transmissions among a plurality of user equipment transmitting one or more uplink channels;

FIG. 2 shows a schematic flow diagram that illustrates the operation of a method, and a result of execution of computer program instructions embodied on a computer readable memory, in accordance with some exemplary embodiments of this invention;

FIG. 3 shows a schematic flow diagram that illustrates the operation of a method, and a result of execution of computer program instructions embodied on a computer readable memory, in accordance with some exemplary embodiments of this invention;

FIG. 4 shows a schematic simplified block diagram of an example electronic device (e.g. user equipment) suitable for use in practising some example embodiments of the invention; and

FIG. 5 shows a schematic simplified block diagram of a first access point or node as an example electronic device suitable for use in practising some example embodiments of the invention.

These and other embodiments and aspects are detailed below with particularity.

### DETAILED DESCRIPTION

Some example embodiments of this invention provide apparatus, methods, and computer programs that provide that a capability report is transmitted from one or more user equipment to at least one access point. The requested capability report indicates an actual amount of additional maximum power reduction applied to one or more network signalling values by the one or more user equipment, which can be for example absolute values or a difference or delta. In other words, the one or more network signalling values reported by the one or more user equipment represent measured actual network signalling values which can be of a lesser value than that set forth in a 3rd Generation Partnership Project (3GPP) standard. In some embodiments, the capability report is sent based upon each one or more user equipment’ response criterion.

Wireless cellular systems such as Long Term Evolution (LTE), LTE-Advance (LTE-A) and future releases such as long-term evolution-beyond (LTE-B) utilise a variation of Orthogonal Frequency-Division Multiple Access (OFDMA) on uplink (UL) channels which is called single carrier frequency division multiple access (SC-FDMA). SC-FDMA is typically described as OFDMA with the addition of a discrete Fourier transform (DFT) applied before subcarrier mapping occurs on the transmitter side, and a corresponding inverse-DFT (IDFT) applied to the UL channel on the receiver side. As a result of the DFT, each subcarrier consists of mapping which represents a function of the entire block of bits including 1, 2, 4 or 6 user bits (depending on the modulation level) adjusted after forward error correction (FEC) and/or interleaving. This is sometimes referred to as DFT-spreading OFDM (or DFTS-OFDM), because of the above described “spreading” effect of the DFT.

As known in the art, in a multicarrier system such as OFDM, data are independently modulated onto parallel subcarriers. At any moment in time the resulting signal is a linear combination of the modulated signals of all the subcarriers (i.e. sum of random complex vectors). In carrying out these operations, wireless cellular systems such as LTE seek to avoid high peak-to-average-power ratio (PAPR) to prevent saturating the amplifier and clipping the signal at the front-end of devices such as user equipment (UE). Moreover as known in the art, amplifiers have a limited range of operation over which they are linear. As such, the wider the range of possible PAPR, the less amplification can be performed if the PAPR range is mapped to the linear operation range. Alternatively, the wider the range of PAPR, the more non-linear is the distortion of blocks of bits with high PAPR. Another well-known way of describing the characterisation of non-linear distortion of blocks of bits is the so-called Cubic Metric (CM) which is as a better quantifier of the impact of power amplifier efficiency.

Power that leaks from a transmitted UL channel into adjacent channels can interfere with transmissions in the neighbouring channels or influence inter-cell inference experienced by neighbouring cells that are utilising the same frequency spectrum as the UL channel (as well as the magnitude of these unwanted signals). Accordingly, the transmission output power of each cellular radio transmitter installed in user equipment and/or access nodes (e.g. such as an eNodeB) and transmitting in an Evolved Universal Terrestrial Radio Access Network (E-UTRAN) or legacy radio access network (e.g. Universal Terrestrial Radio Access Network (UTRAN) or Global System for Mobile Communications Enhanced Data rates for GSM Evolution (GERAN)) is required to minimise undesired out-of-band (OOB) emissions and control spurious transmissions to avoid interfering with other radio equipment or systems. For example, as described in 3GPP TS 36. 101, V11.1.0 (2012-06), 3rd Generation Partnership Project; Technical Specification Group Radio Access Network; Evolved Universal Terrestrial Radio Access (E-UTRA); User Equipment (UE) radio transmission and reception (Release 11): “Additional spectrum emission requirements are signalled by the network to indicate that the UE shall meet an additional requirement for a specific deployment scenario as part of the cell handover/broadcast message.” To that end, the user equipment (UE) is limited to a maximum output power of 23 dBm in UE Power Class 3. The UE must satisfy this requirement within a range of ±2 dB in most bands. However, for some bands this range can be relaxed to −2 dB. An eNodeB employs an additional maximum power reduction scheme (A-MPR) to keep the one or more UE transmission levels below the desired level for specific deployment scenarios, such as carrier aggregation (CA) operations to comply with regulatory limits (e.g. Federal Communications Commission regulations). The A-MPR scheme is a predetermined list which describes certain combinations of E-UTRAN bands, channel bandwidths and transmission bandwidths for UEs in single-band operation scenarios in accordance with Table 6.2.4-1 in 3GPP TS 36.101.

Release 10 of LTE provides a mechanism to trigger a UE to transmit a power headroom report (PHR) to a core network for use by a scheduler. However, the PHR only provides information regarding each UE's maximum transmit power, P_{CMAX}. That is, each UE is allowed to configured its nominal P_{CMAX} (i.e. the highest power that the UE will transmit). The configured P_{CMAX} is set within the following upper and lower boundaries:

P_{CMAX L}≦P_{CMAX}≦P_{CMAX H}

where

P_{CMAX}_{_{—}}_{L}=MIN {P_{EMAX}−ΔT_{C}, P_{PowerClass}−MAX(MPR+A-MPR, P-MPR)−ΔT_{C}}P_{CMAX}_{_{—}}_{H}=MIN {P_{EMAX}, P_{PowerClass}} (Equation No. 1)

Each UE's P_{CMAX}, therefore is defined as a range of values which are the required decibel levels assigned to each network signalling (NS) value in the A-MPR scheme described above with reference to the above mentioned 3GPP specification. As seen in Equation No. 1, the higher limit value range depends on the UE's power class P_{PowerClass} and P_{EMAX}, which is the maximum transmit power that may be signalled by the network. P_{PowerClass} and P_{EMAX} are configured based on the applicable modulation scheme employed and transmit bandwidth configuration (resource block (RB) allocation), and respective MPR decibel level. Also, in Equation No. 1 is ΔT_{C} which can for example be a 1.5 dB reduction in the lower limit of the maximum output power range when the signal is within 4 MHz of the channel edge. Also introduced in Release 10, each UE equipped with multiple transceivers is capable of providing power management MPR (P-MPR) of each transceiver, such as reducing the power on UL channels which occur simultaneously. As such, each UE's P_{CMAX} included in a PHR only indicates MPR+A-MPR in the situation where P-MPR is not employed (or small enough in Equation No. 1 (i.e. the MAC( ) operation) where P-MPR does not dominate). In other words, an eNodeB receiving the PHR has no way of knowing if P-MPR is driving each UE's P_{CMAX}. A-MPR is likely static in most deployment scenarios (e.g. hardcoded in the firmware or software of the UE) and P-MPR more likely dynamic (e.g. P-MPR might be triggered by the UE's proximity sensor). Alternatively, P-MPR might vary depending upon future 3GPP releases specifying power reduction related to inter-band carrier aggregation (CA).

As described in more detail below, some example embodiments of the present invention provide an alternative to the prior art such the PHR. For example, in one embodiment of the present invention a capability report is transmitted from one or more user equipment to at least one access point. The requested capability report indicates an actual amount of MPR+A-MPR applied to one or more NS values by the one or more user equipment, which can be absolute values or a delta. The term “delta” (δ) as used throughout this disclosure refers to either (i) changes in measurable output power levels in the cellular transmitters installed in each UE in reference to MPR specified in various 3GPP technical specification such as for example 3GPP 36.101 and (ii) changes in measured A-MPR in reference to A-MPR specified in various 3GPP technical specification such as for example 3GPP 36.101. The changes can be infinitesimal but measurable, less than zero and determined by known calculation methods. In other words, the one or more network signalling values reported by the one or more user equipment represent actual NS values which can be a lesser decibel level than that set forth in a 3GPP standard. Also, by reporting exclusively actual A-MPR (e.g. not including P-MPR) to the core network (CN), the network scheduler can have a more accurate picture of the network capabilities (e.g. the actual power reduction capabilities of each UE). As such, some embodiments provide enhanced scheduling and therefore enhanced throughput and coverage.

In some example embodiments of the present invention, the eNodeB receiving a UE's capability report will know the behaviour of that device with respect to resource block (RB) allocation in advance of connecting to the UE. Accordingly, the eNodeB may not need to engage in multiple iterations with the UE to determine that information. Furthermore in the case where the eNodeB does not obtain the UE's capability report, as P-MPR changes it may take a lot of time for an eNodeB to really know the actual A-MPR amounts because, as mentioned above, the varying P-MPR would cause variation to resulting P_{CMAX} provided to the CN in the PHR.

In one non-limiting example implementation of the present invention, Band 13 in an UL channel can be adapted or configured in a UE without utilising any A-MPR by using certain ultra-modern design techniques. As a result of not utilising any A-MPR in Band 13, there could be potentially up to a 12 dB improvement in maximum output power level. Another non-limiting implementation of the present invention could implement band 13 in an UL channel where the UE is adapted or configured utilising less A-MPR than that specified for NS_{—}07. However, the network scheduler would not know the power capability of that UE and instead would assume that the UE utilises a high A-MPR level in accordance with the current 3GPP speciation. Hence, the network scheduler might not use RB allocations that would require this high A-MPR. Instead, the scheduler might use those allocations that require less A-MPR, resulting in inefficient spectrum usage.

It should be noted that A-MPR is defined as a fixed threshold announcing the maximum allowed power reduction value. If a UE could survive without it, it could set A-MPR to a lower number, even zero. However, at least some network operators are not that intelligent. For example, at least some of the schedulers from major network vendors assume UE will use maximum allowed A-MPR numbers in each NS value. As a result, full network capability is not taken into use if the UE uses less than the maximum allowed A-MPR and thus provides greater throughput and coverage than the network assumes.

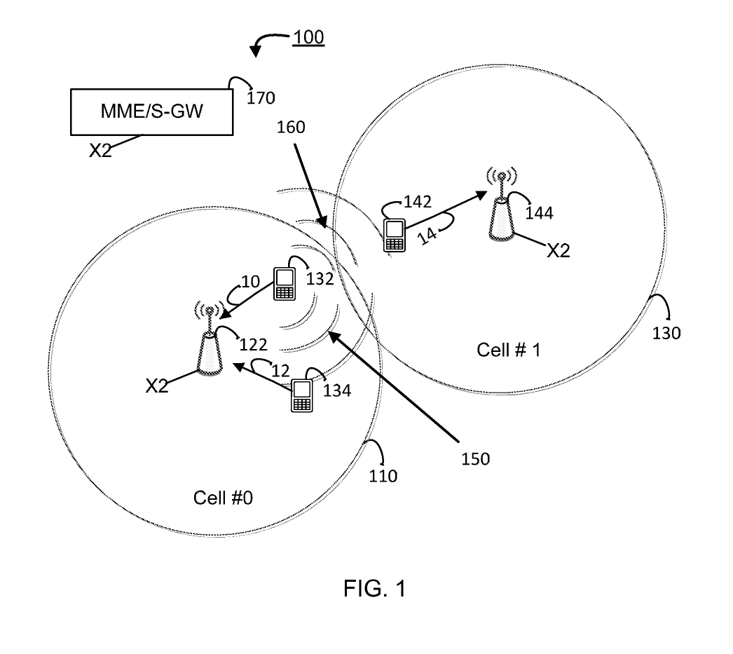

Referring now to FIG. 1 one possible deployment scenario involving out-of-band (OOB) and spurious transmissions among a plurality of user equipment transmitting one or more uplink channels 100 is shown. In FIG. 1, first UE 132 is transmitting on a first UL channel 10 to a first access point 122, such as, for example, an eNodeB. Simultaneously, a second UE 134 is transmitting on a second UL channel 12 to the first access point 122. Both the first UE 132 and second UE 134 are camped on the same macro cell identified as Cell #0 (110). Also proximally located to the first UE 132 and second UE 134 is a third UE 142 which is transmitting on a third UL channel 14 to a second access point 144 which may also be an eNodeB. The third UE 142, although located close to first UE 132 and second UE 134, is camped on a different cell identified in FIG. 1 as Cell #1 (130). The first access point 122 and the second access point 144 are connected via an X2 interface to one or more mobility management entities (MME) and at least one serving gateway (S-GW) 170.

First UE 132 is transmitting on the first channel 10 at a high decibel level which is leaking out-of-band (OOB) and spurious transmissions as indicated by a first OOB/spurious emissions signal 150 and second OOB/spurious emission signal 160. As will be described in more detail in reference to some example embodiments of the present invention, depending upon the LTE band employed, the first OOB/spurious emissions signal 150 and the second OOB/spurious emission signal 160 may or may not cause significant interference among the user equipment in each macro cell.

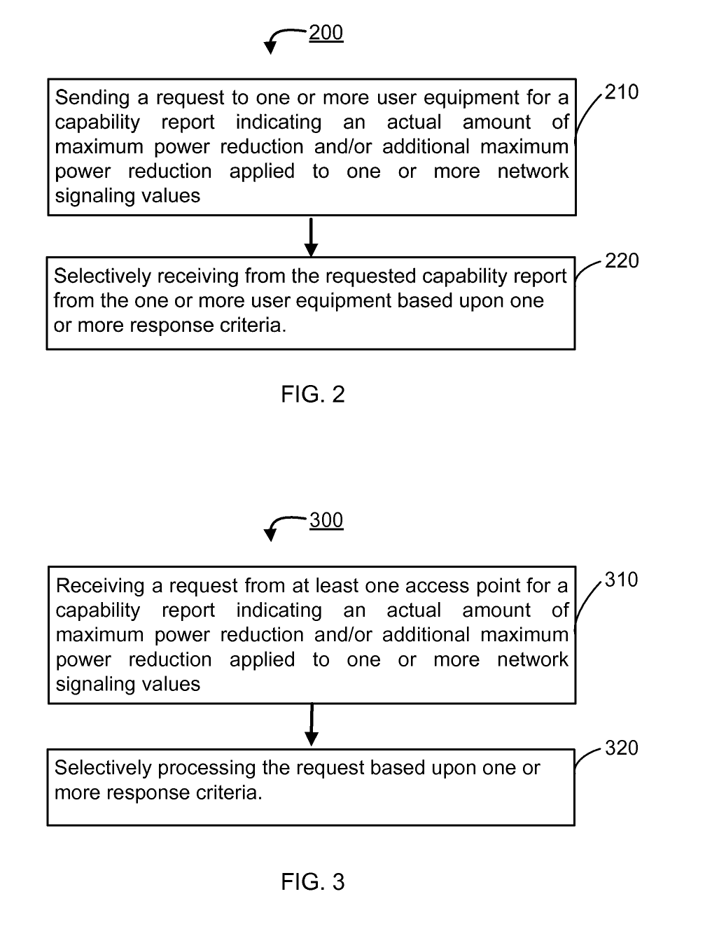

FIG. 2 is a flow diagram that illustrates the operation of a method, and a result of execution of computer program instructions tangibly embodied on a computer readable memory 200, in accordance with some exemplary embodiments of this invention. In particular, FIG. 2 shows the sending of a request to one or more user equipment for a capability report indicating an actual amount of maximum power reduction and/or additional maximum power reduction applied to one or more network signalling values (210) and selectively receiving the requested capability report from the one or more user equipment based upon one or more response criteria (220).

In one example embodiment the response criteria can include ignoring the request if the one or more user equipment are not able to process the request. For example, legacy UTRAN and GERAN devices likely will not be able to process this request and therefore will ignore the request. For user equipment (UE) that are able to process the request, the UE can either (i) disregard the request based upon the one or more user equipment's determination that the user equipment is using the full allowed amount of maximum power reduction and/or additional maximum power reduction applied to the one or more network signalling values or (ii) responding to the request based upon the one or more user equipment's determination that the user equipment is using less than the full amount of maximum power reduction and/or additional maximum power reduction applied to the one or more network signalling values.

In yet another example embodiment, the maximum power reduction applied to the one or more network signalling values is a function of one or more modulation schemes, one or more channel bandwidth and one or more transmission bandwidths relative to a number of transmitted resource blocks. One non-limiting example embodiment is provided below in Table 1.4 as discussed below.

In one example embodiment, the one or more access points transmit the capability report of the one or more user equipment to a core network which propagates the capability report to the access points in the tracking area of the one or more user equipment; or transmits the capability report of the one or more user equipment to one or more access points over an interface. For example, as described above, this capability report can be propagated over the eNodeB's X2 interface. In response to receiving the capability report, the access points can adjust their scheduler in accordance with the reported information related to specific NS values relative to the UE.

Furthermore, another example embodiment provides that the one or more user equipment indicates in the capability report whether one or more numbers it signalled are delta or absolute values. Yet another embodiment provides that the access point requests certain dedicated values from an actual amount of additional maximum power reduction listed in a table located in memory in the one or more user equipment. In one example embodiment, the one or more user equipment transmits a compressed version of an actual amount of additional maximum power reduction table to the one or more access points. In this example embodiment, the one or more user equipment selectively transmit a compressed version of the actual amount of additional maximum power reduction table adapted to one or more 3GPP specified network signalling configurations and limited to a plurality of resource blocks assigned to one or more regions. The compressed version includes (1) one or more measurements of Decibel levels of an additional maximum power reduction relative to the one or more user equipment's performance in the one or more regions, (2) one or more delta measurements of Decibel levels of an additional maximum power reduction relative to the one or more user equipment's performance in the one or more regions, and/or (3) one or more applied additional maximum power reduction Decibel levels relative to an actual additional maximum power reduction value that a network can eventually utilise in the one or more regions, wherein the delta measurement is between or lower than an allowed additional maximum power reduction required by one or more 3GPP network signalling values and the one or more user equipment's applied additional maximum power reduction.

In this example embodiment in one situation, A-MPR can be designated a certain NS configuration in a dB level. One non-limiting example could provide that Band 13 be implemented with only a 2 dB A-MPR level. As such, a UE could signal “2” instead of the entire A-MPR table. As an advantage, simple output power limitation is informed to the core network which could help certain sequencers to work more efficiently. Tables 1.1, 1.2 and 1.3 provide three non-limiting examples of measured A-MPR for NS_{—}07, which is defined in Table 6.2.4-1 of 3GPP 36.101. In each Table, “Spec.” refers to “A-MPR specification” according to TS 36.101, “Meas.” refers to measured UE performance, and “Applied A-MPR” refers to the actual A-MPR value that the core network can eventually utilise.

TABLE 1.1
Example of Measured A-MPR for “NS_07” (rather good UE)

| Parameters | Region A | | Region B | | Region C |
|---|---|---|---|---|---|
| RB_start¹ | 0-12 | | 13-18 | 19-42 | 43-49 |
| L_CRB² [RBs] | 6-8 | 1 to 5 and | ≧8 | ≧18 | ≦2 |
| | | 9-50 | | | |
| Spec. A-MPR [dB] | ≦8 | ≦12 | ≦12 | ≦6 | ≦3 |
| Meas. A-MPR [dB] | ≦1 | ≦2 | ≦1 | 0 | 0 |
| Applied A-MPR [dB] | 2 | 2 | 2 | 2 | 2 |

¹RB_start indicates the lowest RB index of transmitted resource blocks.
²L_CRB is the length of a contiguous resource block allocation.

As shown in Table 1.1, if there was rather modest improvement in certain UL allocation (e.g. 10 dB AMPR is needed in NS_{—}07 Region A), the value signalling may not help much (of course, the specified value cannot be violated): see the example below. Therefore, using maximum A-MPR for compression has the most beneficial effect when a small actual A-MPR level is achieved.

TABLE 1.2
Example of Measured A-MPR for “NS_07” (rather modest UE)

| Parameters | Region A | | Region B | | Region C |
|---|---|---|---|---|---|
| RB_start¹ | 0-12 | | 13-18 | 19-42 | 43-49 |
| L_CRB² [RBs] | 6-8 | 1 to 5 and | ≧8 | ≧18 | ≦2 |
| | | 9-50 | | | |
| Spec. A-MPR [dB] | ≦8 | ≦12 | ≦12 | ≦6 | ≦3 |
| Meas. A-MPR [dB] | ≦6 | ≦10 | ≦8 | 0 | 0 |
| Applied A-MPR [dB] | 8 | 10 | 10 | 6 | 3 |

¹RB_start indicates the lowest RB index of transmitted resource blocks.
²L_CRB is the length of a contiguous resource block allocation.

Alternatively, as shown in Table 1.2, delta between allowed A-MPR given by specified NS-value and UE's actual A-MPR based on the measured value could be calculated, and a minimum delta could be informed to the core network. For example a UE achieved at least 2 dB better A-MPR over the whole NS-table (see example shown in Table 1.3 below). However, an achievement in region A is ignored.

TABLE 1.3
Example of Measured A-MPR for “NS_07” (moderate UE)

| Parameters | Region A | | Region B | | Region C |
|---|---|---|---|---|---|
| RB_start¹ | 0-12 | | 13-18 | 19-42 | 43-49 |
| L_CRB² [RBs] | 6-8 | 1 to 5 and | ≧8 | ≧18 | ≦2 |
| | | 9-50 | | | |
| Spec. A-MPR [dB] | ≦8 | ≦12 | ≦12 | ≦6 | ≦3 |
| Meas. A-MPR [dB] | ≦6 | ≦8 | ≦9 | ≦3 | 0 |
| Delta to NS_07 [dB] | 2 | 4 | 3 | 3 | 3 |
| Applied A-MPR [dB] | 6 | 10 | 10 | 4 | 1 |

¹RB_start indicates the lowest RB index of transmitted resource blocks.
²L_CRB is the length of a contiguous resource block allocation.

Table 1.4 below provides one non-limiting example of a measured maximum power reduction (MPR) for a power class 3 user equipment compared to the current MPR defined in Table 6.2.3-1 in 3GPP 36.101. In this example embodiment the MPR applied to the one or more network signalling values is a function of one or more modulation schemes, one or more channel bandwidth and one or more transmission bandwidths relative to a number of transmitted resource blocks.

TABLE 1.4
Example of Measured MPR

| | Channel bandwidth/ | | | | | | MPR | MPR |
|---|---|---|---|---|---|---|---|---|
| | Transmission bandwidth (RB) | | | | | | (dB) | (dB) |
| Modulation | 1.4 MHz | 3.0 MHz | 5 MHz | 10 MHz | 15 MHz | 20 MHz | Spec. | Meas. |
| QPSK | >5 | >4 | >8 | >12 | >16 | >18 | ≦1 | 0 |
| 16 QAM | ≦5 | ≦4 | ≦8 | ≦12 | ≦16 | ≦18 | ≦1 | 0 |
| 16 QAM | >5 | >4 | >8 | >12 | >16 | >18 | ≦2 | 0 |

In an alternative example embodiment, the measured MPR can be “delta” (δ) which would signify changes in measurable output power levels in the cellular transmitters installed in each UE in reference to MPR specified in various 3GPP technical specification such as for example 3GPP 36.101. In yet another example embodiment, MPR applied to the one or more network signalling values can be a function of 64QAM. In yet another example embodiment, MPR applied to the one or more network signalling values can be a function of channel bandwidth and/or more densely or less densely packed RB block assignments.

In another alternative example embodiment directed to compressing NS value values in formation, the one or more user equipment can transmit at least one maximum amount of additional maximum power reduction level category among a plurality of maximum amount of additional maximum power reduction level categories to the one or more access points.

TABLE 2.1
Desired A-MPR Category level

A-MPR = 0 signal 0 (or ‘000’ in bit level)
A-MPR ≦ 1 → signal 1 (001)
A-MPR ≦ 2 → signal 2 (010)
A-MPR ≦ 3 → signal 3 (011)
A-MPR ≦ 4 → signal 4 (100)
A-MPR ≦ 6 → signal 5 (101)
A-MPR ≦ 9 → signal 6 (110)
A-MPR ≦ 12 → signal 7 (111)

Table 2.1 shown above is but one possible categorisation of desired A-MPR levels to transmit to one or more eNodeB in an LTE network in accordance with one alternative embodiment of the present invention for providing a compressed version of the UE's actual A-MPR table. This alternative embodiment provides a plurality of maximum amount of additional maximum power reduction level categories, including a first category mapping zero Decibels of additional maximum power reduction to a first signal assigned a first binary bit level, a second category mapping 1 or less than 1 Decibels of additional maximum power reduction to a second signal assigned a second binary bit level, a third category mapping 2 or less than 2 Decibels of additional maximum power reduction to a third signal assigned a third binary bit level, a fourth category mapping 3 or less than 3 Decibels of additional maximum power reduction to a fourth signal assigned a fourth binary bit level, a fifth category mapping 4 or less than 4 Decibels of additional maximum power reduction to a fifth signal assigned a fifth binary bit level, a sixth category mapping 6 or less than 6 Decibels of additional maximum power reduction to a sixth signal assigned a sixth binary bit level, a seventh category mapping 9 or less than 9 Decibels of additional maximum power reduction to a seventh signal assigned a seventh binary bit level, and an eighth category mapping 12 or less than 12 Decibels of additional maximum power reduction to an eighth signal assigned an eighth binary bit level. The bit levels, decibel levels, A-MPR levels and NS values shown in Table 2.1 are non-limiting examples and could be altered by for example the second technical specification group (TSG) radio access networks (RAN) working group (WS RAN 2), which is responsible for handling issues related to Layer 2 (e.g., MAC, RLC) and Layer 3 described in the current and future versions of the 3GPP TS 36.300 specification.

There is yet another alternative example embodiment directed to NS values. In this method, the actual amount of maximum power reduction and/or additional maximum power reduction applied to one or more network signalling values is embedded in an Evolved Universal Terrestrial Radio Access Network capability information element identifier (NC IEI) and transmitted to the one or more access points. The NC IEI can in one embodiment be a type 3 information element, which is defined as having a fixed length and at least one octet of content. Alternatively, the NC IEI can be a Type 1 IEI (½ octet of content), a Type 2 IEI (zero octets of content), or a Type 4 IEI (variable length). The first octet can define the IEI as a network capability information element identifier in EUTRAN, which is assigned by a network operator as a one byte unique binary number. The NC IEI can be, for example, an ASN1 signalling which can include the following additional line of code:

| | | |
|---|---|---|
| A-MPRParameters | SEQUENCE { } | OPTIONAL |

(Example Program Code No. 1)

The actual UE signalling could be further refined in one or more TSG RAN working groups such as WS RAN2 or WS RAN4 as this issue relates to UE performance. An alternative embodiment could include the additional signalling information in an UEcapabilityEnquiry signal.

In yet another example embodiment, the one or more user equipment's actual amount of maximum power reduction and/or additional maximum power reduction is stored in firmware and adapted for updating by a user or the core network.

FIG. 3 is a flow diagram that illustrates the operation of a method, and a result of execution of computer program instructions tangibly embodied on a non-transient computer readable memory 300, in accordance with some exemplary embodiments of this invention. In particular, there is shown schematically receiving a request from at least one access point for a capability report indicating an actual amount of maximum power reduction and/or additional maximum power reduction applied to one or more network signalling values (310) and selectively processing the request based upon one or more response criteria (320).

In one example embodiment, the response criteria can include ignoring the request if the one or more user equipment are not able to process the request. For example, legacy UTRAN and GERAN devices likely will not be able to process this request and therefore will ignore the request. For user equipment (UE) that are able to process the request, the UE can either (i) disregard the request based upon the one or more user equipment's determination that the user equipment is using the full allowed amount of maximum power reduction and/or additional maximum power reduction applied to the one or more network signalling values or (ii) responding to the request based upon the one or more user equipment's determination that the user equipment is using less than the full amount of maximum power reduction and/or additional maximum power reduction applied to the one or more network signalling values.

In yet another example embodiment, the maximum power reduction applied to the one or more network signalling values is a function of one or more modulation schemes, one or more channel bandwidth and one or more transmission bandwidths relative to a number of transmitted resource blocks. One non-limiting example embodiment is provided above in Table 1.4 as discussed above.

In one embodiment, the capability report is transmitted to a core network which propagates the capability report to the access points in a tracking area of one or more user equipment. In another embodiment, the capability report is transmitted to one or more access points over an interface such as an X2 interface. In response to receiving that information, the access points adjust their scheduler in accordance with the capability report. In yet another embodiment, the capability report indicates whether one or more numbers signalled by the one or more user equipment are delta or absolute values. Moreover, some example embodiments provide that the one or more access points request certain dedicated values from an actual amount of additional maximum power reduction listed in a table located in memory in the one or more user equipment. In one example embodiment, the one or more user equipment transmits a compressed version of an actual amount of additional maximum power reduction table to the one or more access points. For example as shown in the non-limiting examples in Tables 1.1, 1.2 and 1.3, the one or more user equipment selectively transmits a compressed version of the actual amount of additional maximum power reduction table adapted to one or more 3GPP specified network signalling configurations and limited to a plurality of resource blocks assigned to one or more regions. The compressed version includes one or more measurements of Decibel levels of an additional maximum power reduction relative to the one or more user equipment's performance in the one or more regions one or more delta measurements of Decibel levels of an additional maximum power reduction relative to the one or more user equipment's performance in the one or more regions, or one or more applied additional maximum power reduction Decibel levels relative to an actual additional maximum power reduction value that a network can eventually utilise in the one or more regions. In one example embodiment, the delta measurement is between or lower than an allowed maximum power reduction and/or additional maximum power reduction required by one or more 3GPP network signalling values and the one or more user equipment's applied maximum power reduction and/or applied additional maximum power reduction.

In an alternative example embodiment, the one or more user equipment transmits at least one maximum amount of additional maximum power reduction level category among a plurality of maximum amount of additional maximum power reduction level categories to the one or more access points. A non-limiting example is shown above in Table 2.1 which describes a plurality of maximum amount of additional maximum power reduction level categories, including a first category mapping zero Decibels of additional maximum power reduction to a first signal assigned a first binary bit level, a second category mapping one or less than 1 Decibels of additional maximum power reduction to a second signal assigned a second binary bit level, a third category mapping 2 or less than 2 Decibels of additional maximum power reduction to a third signal assigned a third binary bit level, a fourth category mapping 3 or less than 3 Decibels of additional maximum power reduction to a fourth signal assigned a fourth binary bit level, a fifth category mapping 4 or less than 4 Decibels of additional maximum power reduction to a fifth signal assigned a fifth binary bit level, a sixth category mapping 6 or less than 6 Decibels of additional maximum power reduction to a sixth signal assigned a sixth binary bit level, a seventh category mapping 9 or less than 9 Decibels of additional maximum power reduction to a seventh signal assigned a seventh binary bit level, and an eighth category mapping 12 or less than 12 Decibels of additional maximum power reduction to an eighth signal assigned an eighth binary bit level.

In yet another example embodiment, the actual amount of maximum power reduction and/or additional maximum power reduction applied to one or more network signalling values is embedded in an Evolved Universal Terrestrial Radio Access Network capability information element and transmitted to the one or more access points. Moreover, in one possible non-limiting embodiment, the user equipment's actual amount of maximum power reduction and/or additional maximum power reduction is stored in a firmware and adapted for updating by a user or the core network.

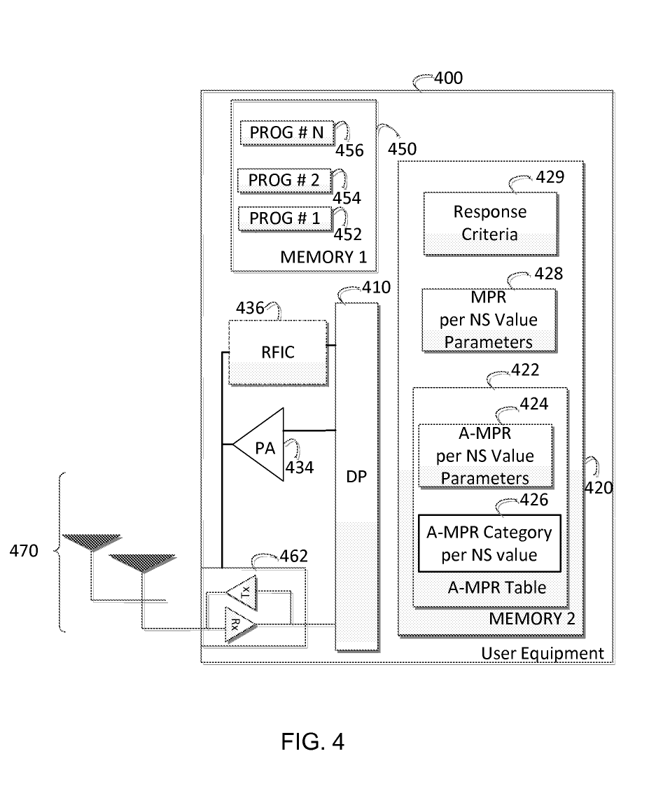

Referring now to FIG. 4, a simplified block diagram of a UE 400 is shown as an example of an electronic device suitable for use in practising some example embodiments of the invention. UE 400 includes one or more processors, such as at least one data processor (DP) 410, and a first computer-readable memory 450 which stores a plurality of computer programs such as PROG #1 (452), PROG #2 (454) and PROG #N (456), suitable for carrying out the various example embodiments of the present invention. A second computer-readable memory 420 stores an A-MPR Table 422 which includes A-MPR parameters 424, as well as various related A-MPR categories 426 in accordance with example embodiments of the present invention. Also, second computer-readable memory 420 stores MPR parameters 428 related to measured MPR in accordance with example embodiments of the present invention. Moreover, second computer-readable memory 420 stores a response criterion or criteria 429 such as a determination to disregard a request for a capability report from an access point based upon the user equipment's determination that the user equipment is using the full allowed amount of either the maximum power reduction or additional maximum power reduction applied to the one or more network signalling values or the user equipment's determination to respond to the access point’ request based upon the one or more user equipment's determination that the user equipment is using less than the full amount of additional maximum power reduction applied to the one or more network signalling values.

The DP 410 and PROG #1 (452) can be triggered, for example, by receiving a network capacity information element from an eNodeB which requires that the UE report its actual A-MPR. The DP 410 and PROG #2 (454) can employ A-MPR parameters 424 to selectively send A-MPR categories 426 in accordance with some example embodiments of the present invention. The DP 410 and PROG #N (456) can employ response criteria 429 to selectively send a response or not based upon the response criteria in accordance with some example embodiments of the present invention.

Although FIG. 4 depicts a first computer-readable memory 450 and a second computer-readable memory 420, UE 400 may include one or more memories, or fewer memory units, for carrying out some example embodiments of the present invention. Moreover, the programs described above (e.g. PROG #1 (452), and PROG #2 (454)) are not limited to specific memory locations (e.g. a first computer-readable memory 450 and a second computer-readable memory 440). FIG. 4 is merely one possible non-limiting example embodiment of the present invention.

UE 400 may include at least one radio access communication module 462 as well as one or more radio access technology antennas 470. In an alternative embodiment, a radio access communication module can be a modem. In some embodiments, the apparatus performing some embodiments of the invention does not include an antenna. The radio access communication modules can be a Long Term Evolution/Long Term Evolution Advanced/Long Term Evolved Beyond (LTE/LTE-A/LTE-B) transceiver, or any similar transceiver. Such non-limiting examples include any other transceiver capable of communicating with a Universal Mobile Telecommunications System, an Evolved Universal Mobile Telecommunications Terrestrial Radio Access Network, a Global System for Mobile communications, a Universal Terrestrial Radio Access network, or cellular networks employing Wideband Code Division Multiple Access or High Speed Packet Access.

UE 400 may further include a power amplifier (PA) 434 and a radio frequency integrated circuit (RFIC). RFIC 436 may, for example, include various radio frequency components, such as a low noise amplifier circuit, to support one or more low power supply voltage operations, include integration of an automatic calibration circuit, include circuitry for multi-mode and multi-band operation (so-called “one chip solution”) and an optimised single-chip RFIC solution for carrier aggregation. In another example embodiment, RFIC 436 can include a field programmable gate array or combinational logic and one or more power amplifiers adapted for controlling the maximum output power of one or more transceivers as a function of one or more modulation schemes, one or more channel bandwidth, and one or more transmission bandwidths relative to a number of transmitted resource blocks.

In yet another embodiment, RFIC 436 may also include support for low power consumption by the most suitable clock frequency operation, fully flexible design with MPU integration in RFIC which allows for fully flexible support and ease of integration of RFIC into different RF subsystem topologies. RFIC 436 may also include support for many wireless access systems, for example, a Universal Mobile Telecommunications System, an Evolved Universal Mobile Telecommunications Terrestrial Radio Access Network (E-UTRAN), a Global System for Mobile communications (GSM), a Universal Terrestrial Radio Access network (UTRAN), or cellular networks employing Wideband Code Division Multiple Access (WCDMA) or High Speed Packet Access (HSPA).

UE 400 can be, for example, a cellular phone, a personal digital assistant, a wireless modem, a wireless communication device, a laptop computer, a netbook, a tablet computer or any other device cable of communicating with an Evolved Universal Terrestrial Radio Access Network, Universal Terrestrial Radio Access Network or Global System for Mobile EDGE Radio Access Network enabled device.

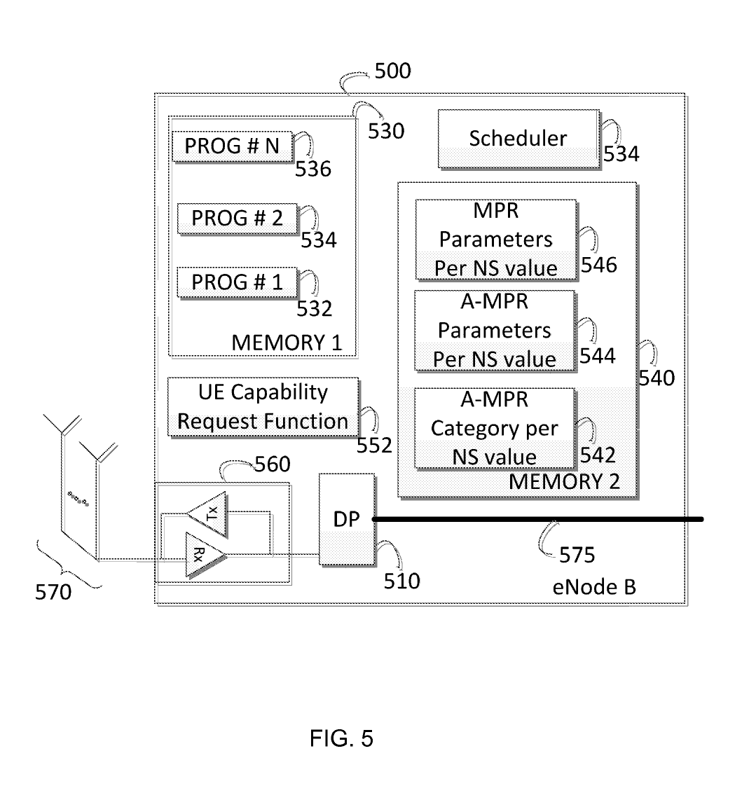

Referring now to FIG. 5, a simplified block diagram of a first access point or Node, which can be an evolved Node B (eNodeB) 500, is shown as an example suitable electronic device for use in practising some example embodiments of the invention. In some example embodiments, eNodeB 500 can be a base station, node B, femto evolved node B, or pico node B, or any other device cable of communicating with an Evolved Universal Terrestrial Radio Access Network, Universal Terrestrial Radio Access Network, or Global System for Mobile EDGE Radio Access Network. eNodeB 500 includes one or more processors, such as at least one data processor (DP) 510, a first computer-readable memory 530 (which stores a plurality of computer programs such as PROG #1 (532), PROG #2 (534) and PROG #N (536)), suitable for carrying out the various example embodiments of the present invention. A second computer-readable memory 540, stores one or more A-MPR parameters 544 received from one or more UEs in accordance with some example embodiments of the present invention. In addition, the second memory 540 includes one or more A-MPR categories 542 received from one or more UEs in accordance with some example embodiments of the present invention. In addition, second computer-readable memory 540, stores one or more MPR parameters 546 received from one or more UEs in accordance with some example embodiments of the present invention.

The DP 510 and PROG #1 (532) can be employed together with the UE capability request function 552 to send one or more UE capability requests to a plurality of user equipment in accordance with some example embodiments of the present invention. The DP 510 and PROG #2 (534) can be employed to propagate the one or more MPR parameter 546 and/or A-MPR categories 542 or one or more A-MPR parameters 544 among eNodeBs by way of its X2 interface 575. Also shown in FIG. 5 is scheduler 546 which is adapted or configured to coordinate NS signalling among uplink and downlink channels of the user equipment for example in an E-UTRAN or legacy radio access network such as UTRAN or GERAN.

Although FIG. 5 depicts a first computer-readable memory 530 and a second computer-readable memory 540, eNB 500 may include one or more memories, or fewer memory units, for carrying out some example embodiments of the present invention. Moreover, the programs described above (e.g., PROG #1 (532) and PROG #2 (534)) are not limited to a specific memory location (e.g. first computer-readable memory 530 and second computer-readable memory 540). FIG. 5 is merely one possible non-limiting example embodiment of the present invention.

eNB 500 also includes at least one radio access communication module 560 and one or more radio access technology antennas 570. The radio access communication module 360 can be a Long Term Evolution/Long Term Evolution Advanced/Long Term Evolved Beyond (LTE/LTE-A/LTE-B) transceiver, or any similar transceiver. Such non-limiting examples include any other transceiver capable of communicating with a Universal Mobile Telecommunications System, an Evolved Universal Mobile Telecommunications Terrestrial Radio Access Network, a Global System for Mobile communications, a Universal Terrestrial Radio Access network, or cellular networks employing Wideband Code Division Multiple Access or High Speed Packet Access.

In these regards, the non-limiting example embodiments of this invention may be implemented at least in part by computer software stored on non-transitory memory which is executable by a processor, or by hardware, or by a combination of tangibly stored software and hardware (and tangibly stored firmware). Electronic devices implementing these aspects of the invention need not be the entire devices as depicted at FIGS. 4 and 5, but some example embodiments may be implemented by one or more components of same, such as the above-described tangibly stored software, hardware, firmware and processor or micro-controllers, or a system on a chip (SOC) or an application specific integrated circuit (ASIC).

Various embodiments of the computer readable memory, such as those disclosed in FIG. 4, include any data storage technology type which is suitable to the local technical environment, including, but not limited to, semiconductor based memory devices, magnetic memory devices and systems, optical memory devices and systems, fixed memory, removable memory, disc memory, flash memory, DRAM, SRAM, EEPROM and the like. Various embodiments of the data processors include, but are not limited to, general purpose computers, special purpose computers, microprocessors, digital signal processors (DSPs) and multi-core processors.

As used in this application, the term “circuitry” refers to the of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of “circuitry” applies to the uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example (if applicable to the particular claim element), a baseband integrated circuit or applications processor integrated circuit for a mobile phone or a similar integrated circuit in server, a cellular network device, or other network device. The reference throughout this disclosure to a UE may be embodied on a cellular phone, a personal digital assistant (PDA), a wireless modem, a wireless communication device, a laptop, a netbook, a tablet or any other device cable of communicating with a E-UTRAN, UTRAN or GERAN enabled device.

Further, some of the various features of the above non-limiting example embodiments may be used to advantage without the corresponding use of other described features. The foregoing description should therefore be considered as merely illustrative of the principles, teachings and example embodiments of this invention, and not in limitation thereof.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method, the method comprising:
sending a request to one or more user equipment for a capability report indicating an actual amount of maximum power reduction and/or additional maximum power reduction applied to one or more network signalling values; and
selectively receiving the requested capability report from the one or more user equipment based upon one or more response criteria.

2. A method according to claim 1, wherein the response criteria comprises at least one of:
ignoring the request if the one or more user equipment are not able to process the request;
disregarding the request based upon the one or more user equipment's determination that the user equipment is using the full allowed amount of maximum power reduction and/or additional maximum power reduction applied to the one or more network signalling values; and
responding to the request based upon the one or more user equipment's determination that the user equipment is using less than the full amount of maximum power reduction and/or additional maximum power reduction applied to the one or more network signalling values.

3. A method according to claim 1, wherein the maximum power reduction applied to the one or more network signalling values is a function of one or more modulation schemes, one or more channel bandwidth and one or more transmission bandwidths relative to a number of transmitted resource blocks.

4. A method according to claim 1, wherein one or more access points transmit the capability report of the one or more user equipment to a core network which propagates the capability report to the access points in the tracking area of the one or more user equipment, or transmit the capability report of the one or more user equipment directly to one or more access points over an interface.

5. A method according to claim 4, wherein the one or more access points adjust their scheduler in accordance with the capability report.

6. A method according to claim 4, wherein the one or more access points request certain dedicated values from an actual amount of additional maximum power reduction listed in a table stored in memory in the one or more user equipment.

7. A method according to claim 4, wherein the one or more user equipment transmits a compressed version of an actual amount of additional maximum power reduction table to the one or more access points.

8. A method according to claim 7, wherein the one or more user equipment selectively transmit a compressed version of the actual amount of additional maximum power reduction table adapted to one or more 3rd Generation Partnership Project specified network signalling configurations and limited to a plurality of resource blocks assigned to one or more regions, said compressed version comprising:
one or more measurements of Decibel levels of an additional maximum power reduction relative to the one or more user equipment's performance in the one or more regions;
one or more delta measurements of Decibel levels of an additional maximum power reduction relative to the one or more user equipment's performance in the one or more regions; or
one or more applied additional maximum power reduction Decibel levels relative to an actual additional maximum power reduction value that a network can eventually utilise in the one or more regions,
wherein the one or more delta measurements is between or lower than an allowed additional maximum power reduction required by one or more 3rd Generation Partnership Project network signalling values and the one or more user equipment's applied additional maximum power reduction.

9. A method according to claim 7, wherein the one or more user equipment transmits at least one maximum amount of additional maximum power reduction level category among a plurality of maximum amount of additional maximum power reduction level categories to the one or more access points.

10. A method according to claim 9, wherein the plurality of maximum amount of additional maximum power reduction level categories comprises:
a first category mapping zero Decibels of additional maximum power reduction to a first signal assigned a first binary bit level;
a second category mapping 1 or less than 1 Decibels of additional maximum power reduction to a second signal assigned a second binary bit level;
a third category mapping 2 or less than 2 Decibels of additional maximum power reduction to a third signal assigned a third binary bit level;
a fourth category mapping 3 or less than 3 Decibels of additional maximum power reduction to a fourth signal assigned a fourth binary bit level;
a fifth category mapping 4 or less than 4 Decibels of additional maximum power reduction to a fifth signal assigned a fifth binary bit level;
a sixth category mapping 6 or less than 6 Decibels of additional maximum power reduction to a sixth signal assigned a sixth binary bit level;
a seventh category mapping 9 or less than 9 Decibels of additional maximum power reduction to a seventh signal assigned a seventh binary bit level; and
an eighth category mapping 12 or less than 12 Decibels of additional maximum power reduction to an eighth signal assigned an eighth binary bit level.

11. A method according to claim 1, wherein the one or more user equipment indicates in the capability report whether one or more numbers it signalled are delta or absolute values.

12. A method according to claim 1, wherein the actual amount of maximum power reduction and/or additional maximum power reduction applied to one or more network signalling values is embedded in an Evolved Universal Terrestrial Radio Access Network capability information element and transmitted to one or more access points.

13. Apparatus for use in an access point, the apparatus comprising:
a processing system adapted to cause the apparatus to at least:
send a request to one or more user equipment for a capability report indicating an actual amount of maximum power reduction and/or additional maximum power reduction applied to one or more network signalling values; and
selectively receive the requested capability report from the one or more user equipment based upon one or more response criteria.

14. Apparatus according to claim 13, wherein the response criteria comprises at least one of:
ignoring the request if the one or more user equipment are not able to process the request;
disregarding the request based upon the one or more user equipment's determination that the user equipment is using the full allowed amount of maximum power reduction and/or additional maximum power reduction applied to the one or more network signalling values; and
responding to the request based upon the one or more user equipment's determination that the user equipment is using less than the full amount of maximum power reduction and/or additional maximum power reduction applied to the one or more network signalling values.

15. Apparatus according to claim 13, wherein the maximum power reduction applied to the one or more network signalling values is a function of one or more modulation schemes, one or more channel bandwidth and one or more transmission bandwidths relative to a number of transmitted resource blocks.

16. Apparatus according to claim 13, wherein the processing system is adapted to cause the apparatus to at least:
transmit the capability report of the one or more user equipment to a core network which propagates the capability report to the access points in the tracking area of the one or more user equipment; or
transmit the capability report of the one or more user equipment to one or more access points.

17. Apparatus according to claim 16, wherein the access point adjusts its scheduler in accordance with the capability report.

18. Apparatus according to claim 16, wherein the at least one access point requests certain dedicated values from an actual amount of additional maximum power reduction listed in a table stored in memory in the one or more user equipment.

19. Apparatus according to claim 16, wherein the apparatus is arranged to receive a compressed version of an actual amount of additional maximum power reduction table transmitted by the one or more user equipment to the at least one access point.

20.-37. (canceled)

38. Apparatus for use in a user equipment, the apparatus comprising:
a processing system adapted to cause the apparatus to at least:
receive a request from at least one access point for a capability report indicating an actual amount of maximum power reduction and/or additional maximum power reduction applied to one or more network signalling values; and
selectively process the request based upon one or more response criteria.

39-50. (canceled)
